(19) United States
(12) Patent Application Publication
(10) Pub. No.: US 2003/0188162 A1
(43) Pub. Date: Oct. 2, 2003

(54) Locking a hard drive to a host

(76) Inventors: Brant Candelore, Escondido, CA (US); Kim Ryal, Poway, CA (US)

Correspondence Address: Archana B. Vittal, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/109,901

(22) Filed: Mar. 29, 2002

(51) Int. Cl. H04L 9/00

(52) U.S. Cl. 713/169

(57) ABSTRACT

A hard drive is locked to a particular host using a first key associated with the host. The locked hard drive sends a challenge to a current host. The current host encodes the challenge with a second key and sends the encoded result to the hard drive. The hard drive verifies the encoded result against the challenge using the first key. If the verification fails, the hard drive denies access to the current host.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2001, Sony Electronics, Inc., All Rights Reserved.

### FIELD OF THE INVENTION

This invention relates generally to hard drives, and more particularly to locking a hard drive to a host.

### BACKGROUND

Currently, many electronic devices involve complex functions that involve the use of a hard drive. A hard drive is a mechanism that reads and writes data on a hard disk. Examples of some electronic devices in the entertainment arena that may use a hard drive include music players such as MP3 players, and home entertainment systems such as set-top boxes that receive satellite and cable television channels. MP3 players allow users to download music files from the Internet and play them at near-CD quality. TV set-top boxes allow programs to be recorded with VCR and live-pause capability.

Other electronic devices that utilize a hard drive include personal computers and personal digital assistants (PDAs). Personal computers are capable of performing a variety of functions that require hard drive capabilities, such as downloading content from the Internet. Laptops and PDAs similarly require the hard drive to perform many functions.

Since an increasing number of electronic devices are becoming hard drive enabled, many of these electronic devices are subsidized by service providers to lower the initial cost for a customer. A problem exists today where buyers are capitalizing on the subsidized appliances by removing the hard drive from the electronic device and using it elsewhere. Hard drives may be taken out of the electronic device, and used for other purposes that were not intended by the electronic device manufacturer or service provider. For example, a hard drive in a set-top box may be physically removed from the set-top box. Once removed, the hard drive may be utilized with any number of hosts, one being a personal computer. The user benefits by not having to buy an additional hard drive and saving money as a result.

Removing the hard drive and using it with another electronic device is considered unauthorized use by the manufacturer or service provider of the subsidized electronic device. Currently, no prior art exists to prevent this type of unauthorized use.

### SUMMARY OF THE INVENTION

A hard drive is locked to a particular host using a first key associated with the host. The locked hard drive sends a challenge to a current host. The current host encodes the challenge with a second key and sends the encoded result to the hard drive. The hard drive verifies the encoded result against the challenge using the first key. If the verification fails, the hard drive denies access to the current host.

### BRIEF DESCRIPTION OF THE DRAWINGS

The present invention is illustrated by way of example, and not limitation, in the figures of the accompanying drawings in which:

FIG. 1a illustrates a block diagram of one embodiment of a lockable hard drive communicably coupled to a set-top box;

FIG. 1b illustrates a block diagram of one embodiment of a lockable hard drive communicably coupled to a personal computer;

FIG. 1c illustrates a block diagram of one embodiment of a lockable hard drive communicably coupled to a laptop;

FIG. 1d illustrates a block diagram of one embodiment of a lockable hard drive communicably coupled to a personal digital assistant (PDA);

FIG. 2 illustrates a block diagram of one embodiment of a lockable hard drive communicably coupled to a current host;

FIG. 3a illustrates one embodiment of a configuration protocol for a lockable hard drive;

FIG. 3b illustrates a diagram of one embodiment of a locking protocol for a lockable hard drive;

FIG. 4a illustrates one embodiment of a 7-byte DES secret symmetric key;

FIG. 4b illustrates one embodiment of a challenge;

FIG. 4c illustrates one embodiment of an encrypted result;

FIG. 4d illustrates one embodiment of a decrypted result;

FIG. 5 illustrates a flow diagram of one embodiment of a process of configuring a lockable hard drive;

FIG. 6 illustrates a flow diagram of an alternative embodiment of a process of configuring a lockable hard drive;

FIG. 7 illustrates a flow diagram of one embodiment of a process of verifying a host with a lockable hard drive;

FIG. 8 illustrates a flow diagram of an alternative embodiment of a process of verifying a host with a locked hard drive; and

FIG. 9 illustrates one embodiment of a computer system.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

The invention locks a hard drive to a hard drive enabled electronic device (host) so that the hard drive will not operate when removed from the electronic device. A hard drive is defined to be a non-integrated, non-volatile mass storage. On power up or reset event, the host requests the lock status from the hard drive. If the hard drive is locked, it responds with a challenge to a current host. The current host encodes the challenge and returns the encoded result to the hard drive. The hard drive verifies the encoded result against the challenge using a first key associated with a particular host. If the verification fails, the current host is denied access to the hard drive. The drive acknowledges success or failure to the host.

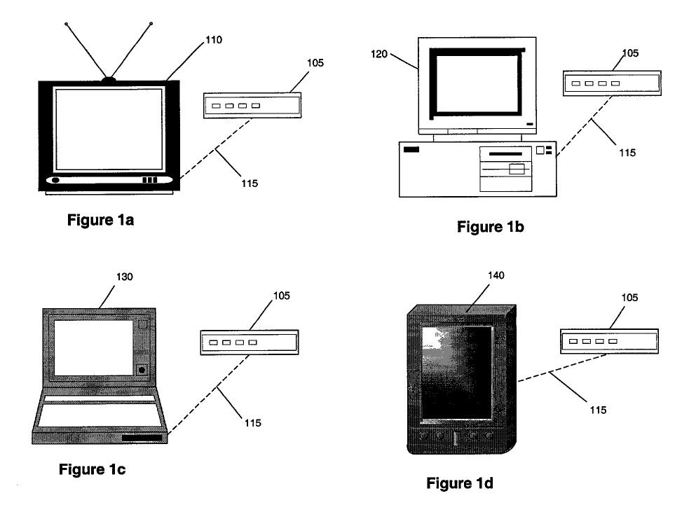

FIGS. 1a-1d illustrate a lockable hard drive communicably coupled to different hard drive enabled electronic devices. In different embodiments, the hard drive may be communicably coupled to any number of different electronic devices. For example, in one embodiment, as seen In FIG. 1a, the hard drive is coupled to a set-top box 110. In an alternative embodiment, as seen in FIG. 1b, the hard drive is coupled to a personal computer 120. In FIG. 1c, the hard drive is coupled to a laptop 130. In FIG. 1d, the hard drive is coupled to a personal digital assistant (PDA) 140. In other alternative embodiments, the hard drive is communicably coupled to other electronic devices such as an MP3 player or a home entertainment system.

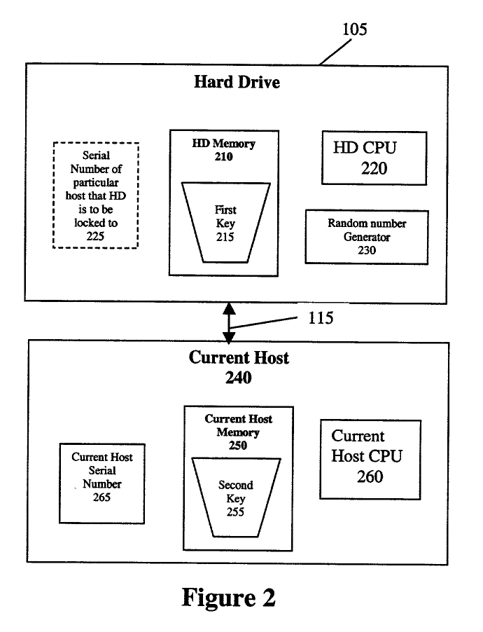

FIG. 2 illustrates a block diagram of one embodiment of a lockable hard drive 105 communicably coupled to a current host 240. In FIG. 2, the hard drive 105 includes a hard drive (HD) memory 210, a HD central processing unit (CPU) 220, and a random number generator 230. The current host 250 includes a current host memory 250 and a current host CPU 260. The HD memory 210 contains a first key 215. The current host memory 250 contains a second key 255.

The hard drive 105 is coupled to the current host 240 via a communication link 115. In one embodiment, the communication link 115 is Institute of Electrical and Electronics Engineers (IEEE) 1394 bus (“Firewire”). In alternative embodiments, the communication link 115 may conform to any of the following bus types: Integrated Drive Electronics (IDE), Small Computer Systems Interface (SCSI), Universal Serial Bus (USB), Parallel, and Advanced Technology Attachment (ATA). A wireless link such as IEEE 802.11a, b, or g is also contemplated as within the scope of the invention.

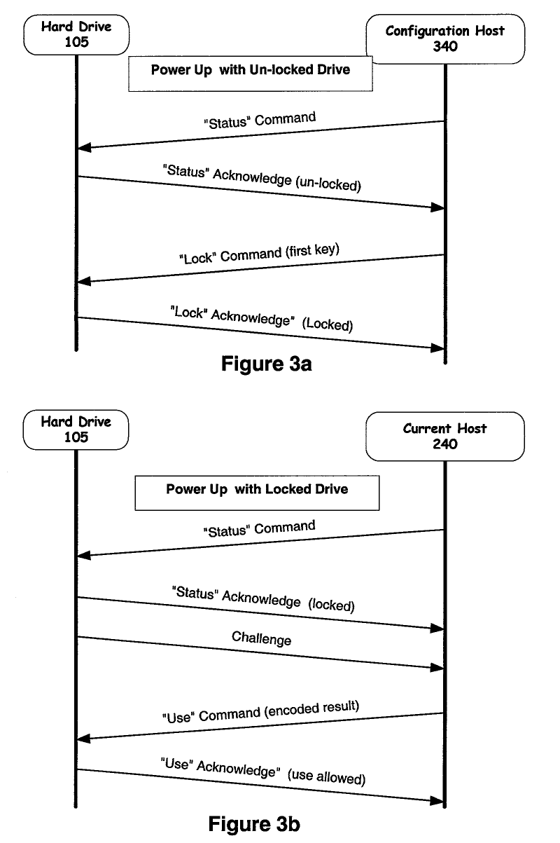

FIG. 3a illustrates a diagram of one embodiment of a configuration protocol for a lockable hard drive 105. At unit creation time, a configuration host 340 sends a status command to the hard drive 105 when the hard drive 105 powers up. The hard drive 105 sends a status acknowledgement that contains a bit that flags whether or not the hard drive 105 has been “locked”. If the hard drive 105 is unlocked, the power-up status is sent as “un-locked” to the configuration host 340. In response, the configuration host 340 sends a lock command including a first key that is then stored in the hard drive's memory. The hard drive 105 then sets the “lock” bit, preventing a re-loading of the first key in the hard drive. The hard drive 105 sends a lock acknowlement to the configuration host 340.

In one embodiment, the first key is a random number generated by the host each time a hard drive needs to be locked. This is to prevent “spoofing” an unlocked hard drive in order to get the host to send the original first key again so that the first key may be revealed to someone trying to improperly re-use the hard drive. If the first key is a random number, then subsequent first keys would bear no relationship to the original first key. Accordingly, the first key could not help a person that was attempting to re-use the hard drive. In one embodiment, the first key is stored in the hard drive's flash memory.

Once the first key is stored, subsequent power-ups of the hard drive 105 follow the locking protocol shown in FIG. 3b. FIG. 3b illustrates one embodiment of a locking protocol for a lockable hard drive 105.

The hard drive 105 is configured with special firmware that on powerup or reset will verify “locked” status to a particular host 240 prior to executing a command. If it is locked, then the hard drive 105 will verify that the current host 240 that it is loaded into is the particular host that contains the right key. No other commands are accepted by the hard drive 105 except the status, lock, un-lock or use commands, until the current host 240 is verified.

Referring to FIG. 3b, to verify the host 240, the hard drive 105 responds to the host's status command with the locked state. The hard drive 105 then sends a challenge for the current host 240 to encode. In one embodiment, the challenge is a random number. The current host 240 encodes the challenge with a second key. The host 240 sends the encoded result back to the hard drive 105 in a use command.

The hard drive 105 decodes the encoded result and checks it. The hard drive 105 then sends a success or failure indication in a status acknowledge response. If the decoded result matches the challenge, the hard drive 105 sends . the configuration result as “Ok”. If the decoded result does not match the challenge, the hard drive 105 sends the configuration result as “Fail”.

If the configuration result is “Fail”, the current host will be denied access to the hard drive 105. In one embodiment, the hard drive 105 will refuse to accept any other commands from the current host 240 except for the status, lock, unlock and use commands. In an alternative embodiment, the hard drive 105 will refuse to communicate with the current host 240 until a reset or power cycle. In another alternative embodiment, the hard drive 105 will erase its contents.

In one embodiment, the first key and the second key are secret symmetric keys. In this case, the symmetrical cryptographic algorithm may be Digital Encryption Standard (DES) or Triple-DES. In alternative embodiments, the symmetrical cryptology algorithm may be Advanced Encryption Algorithm (AES), Blowfish, or M6.

In one embodiment, a hashing algorithm can also be employed whereby the key is implied in the data being hashed. In that case, a hash of the challenge is generated by the current host using the second key and compared to a hash generated by the hard drive using the first key. If the hashes are the same, the hard drive continues communication with the current host. In one embodiment, the hashing algorithm may be Secure Hashing Algorithm rev.1 (SHA-1). In an alternative embodiment, the hashing algorithm may be MD5.

In one embodiment, the first and second keys are not symmetric but a public key cryptography key pair. In this case, the public key algorithm may be RSA. In alternative embodiments, the public key algorithm may be Elliptic Curve, N-tru, or Diffie-Hellman.

In one embodiment, the lock bit is written to one time programmable (OTP) memory and not changeable. In alternative embodiments, the lock bit may be re-programmable. Under the right conditions, the use of a master key may be used to revert the hard drive to an un-locked condition. This would be useful in the instance where the host has failed. The hard drive might be taken to a repair facility, where the hard drive might be extracted from a particular host, unlocked, and re-locked into a different host. Since reversion to the unlocked state would be done in a secure environment, the protocol can be very simple. A request to un-lock a hard drive can be accompanied by an additional field containing the secret master key. The hard drive would confirm the validity of the master key before unlocking the hard drive. The master key used to unlock a hard drive can be unique for that particular hard drive. The master key can also be made to change based on a secret algorithm with each lock operation.

In one embodiment, at creation time, the configuration host can write the serial number of the particular host the hard drive is to be locked to into the hard drive along with the first key information. On subsequent power ups, if the hard drive fails to make a match with the challenge, it can output that serial number of the particular host that it was originally “locked” to along with any failure response message. The current host may display this in a message stating that the hard drive was already bound to a different host. The current host serial number 265 is shown on the current host 240 in FIG. 2. The serial number of the particular host the hard drive is to be locked to 225 is also shown as an optional component in the hard drive 105 in phantom.

In one embodiment, the host uses tamper resistance for a flash memory to prevent replacement of the first key by a value known to a hacker. The tamper resistance would also prevent clearing of the “lock” bit, which would put the hard drive back into an “unlocked” state.

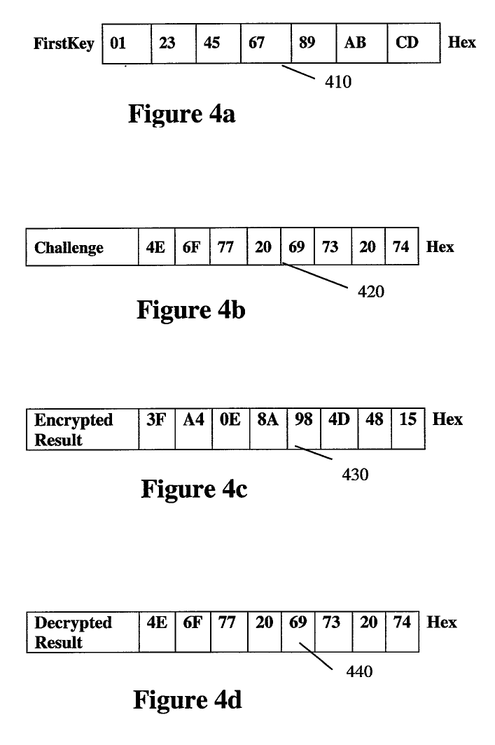

A specific example of the locking the hard drive using DES is discussed below with reference to FIGS. 4a-4e. FIG. 4a illustrates one embodiment of a 7-byte DES secret symmetric key 410. The hard drive stores the key 410 and “locks” the drive. FIG. 4b illustrates one embodiment of a challenge 420. As seen in FIG. 4b, the challenge 420 is a 64-bit random number generated by the hard drive. The challenge 420 is sent to the current host to be encrypted.

FIG. 4c illustrates one embodiment of an encrypted result 430. The current host encrypts the challenge 420 and sends the challenge 420 back to the hard drive. FIG. 4d illustrates one embodiment of a decrypted result 440. The hard drive uses the secret symmetric key 410 to decrypt the encryped result 430 received from the current host. The hard drive checks to see if the decrypted result 440 matches the challenge 420 that was sent to the host. Since it matches in this case, then the drive operates normally.

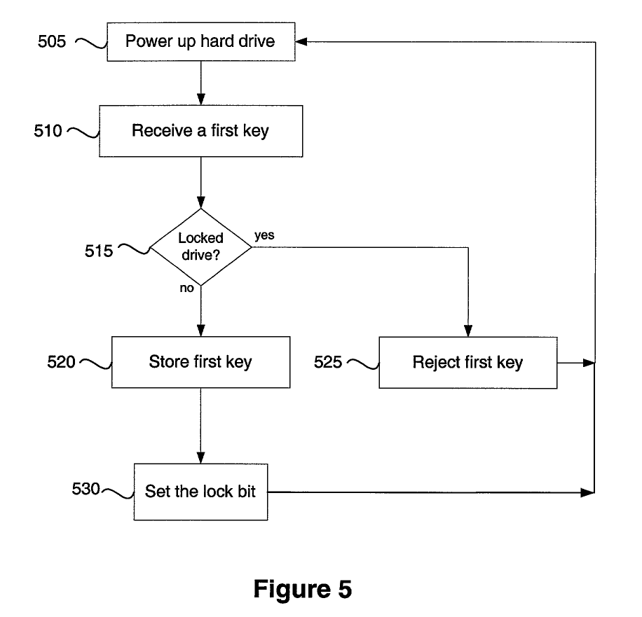

FIG. 5 illustrates a flow diagram of one embodiment of a process 500 of configuring a lockable hard drive. At processing block 505, the hard drive powers up. At processing block 510, the hard drive receives a first key from a configuration host. At processing block 515, processing logic determines if the hard drive is locked. If yes, the process moves to processing block 525, and the hard drive rejects the first key.

At processing block 515, if processing logic determines that the hard drive is not locked, the process moves to processing block 520. At processing block 520, the hard drive stores the first key. At processing block 530, a lock bit is set.

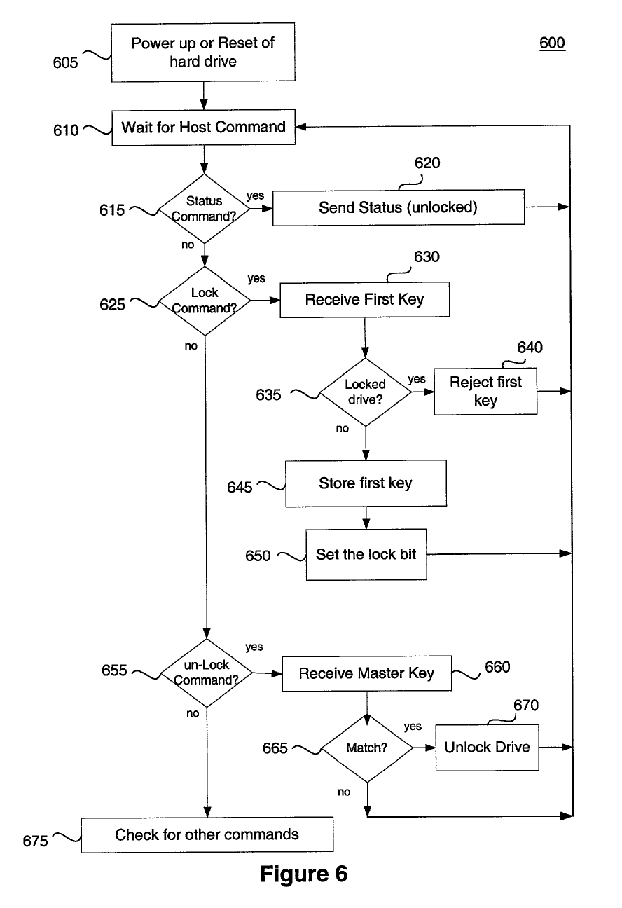

FIG. 6 illustrates a flow diagram of an alternative embodiment of a process 600 of configuring a lockable hard drive. At processing block 605, the hard drive powers up or reset occurs. At processing block 610, the hard drive waits for a command from the host. At processing block 615, processing logic determines whether the command is a status command. If yes, the process moves to processing block 620, and the hard drive sends an unlocked status to the host. If no, the process moves to processing block 625.

At processing block 625, processing logic determines if the command is a lock command. If yes, the process moves to processing block 630, and the hard drive receives a first key. At processing block 635, processing logic determines of the hard drive is locked. If yes, the process moves to processing block 640, and the hard drive rejects the first key. If no, the process moves to processing block 645, and the hard drive stores the first key. At processing block 450, the hard drive sets the lock bit.

Referring back to processing block 625, if processing logic determines that the command is not a lock command, then the process moves to processing block 655. At processing block 655, processing logic determines if the command is an un-lock command. If yes, the process moves to processing block 660, and the hard drive receives a master key. At processing block 665, processing logic determines if the master key is a match. If yes, then the process moves to processing block 670, and the hard drive is unlocked with the master key. If no, the process moves back to processing block 610, and the hard drive waits for another command from the host.

Referring back to processing block 655, if processing logic determines that the command is not an un-lock command, then the process moves to processing block 675. At processing block 675, the hard drive checks for other commands.

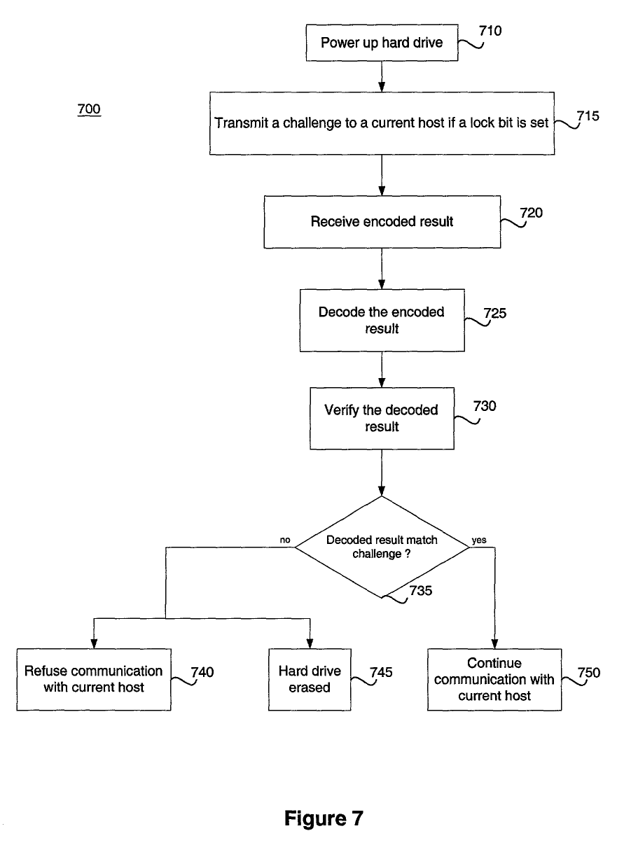

FIG. 7 illustrates a flow diagram of one embodiment of a process 700 of verifying a host with a lockable hard drive. At processing block 710, the hard drive powers up. At processing block 715, the hard drive transmits a challenge to a current host if a lock bit is not set. At processing block 720, the hard drive receives an encoded result from the current host. At processing block 725, the hard drive decodes the encoded result. At processing block 730, the hard drive verifies the decoded result. At processing block 735, the hard drive determines if the decoded result matches the challenge. If yes, the hard drive continues communication with the host at processing block 750. If no, the hard drive either refuses communication as seen at processing block 740 with the current host or erases its contents as seen at processing block 745.

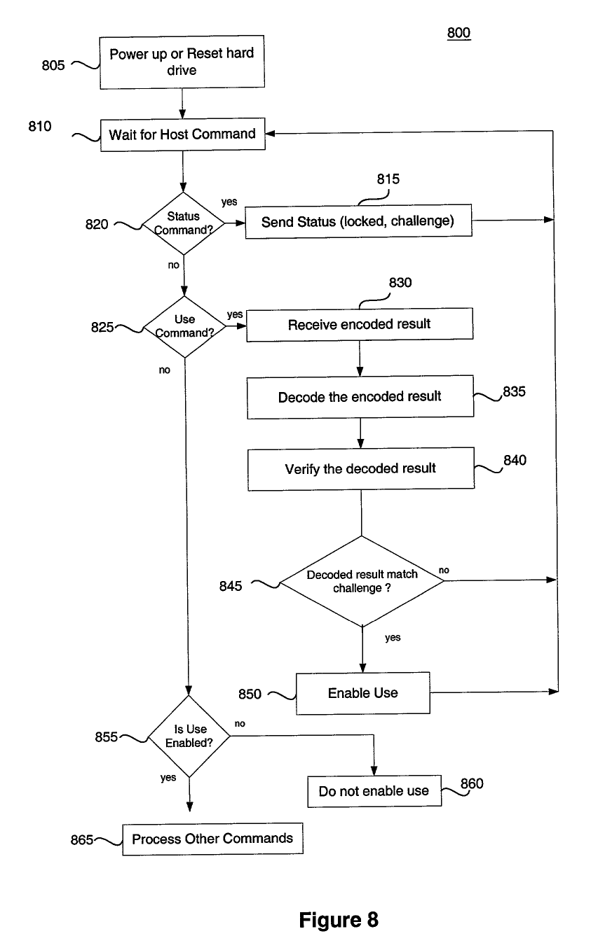

FIG. 8 illustrates a flow diagram of an alternative embodiment of a process 800 of verifying a host with a locked hard drive. At processing block 805, the hard drive powers up or resets. At processing block 810, the hard drive waits for a command from a current host. At processing block 820, processing logic determines if the command received from the host is a status command. If yes, the process moves to processing block 815, and the hard drive sends a locked status and a challenge to the host.

If no, the process moves to processing block 825. At processing block 825, processing logic determines if the command received from the host is a use command. If yes, the process moves to processing block 830, and the hard drive receives an encoded result from the host. At processing block 835, the hard drive decodes the encoded result. At processing block 840, the hard drive verifies the decoded result.

At processing block 845, the hard drive determines if the decoded result matches a challenge previously sent to the host. If yes, the process moves to processing block 850, and the host is enabled to use the hard drive. If no, the process moves to processing block 810, and the hard drive waits for another command from the host.

Referring back to processing block 825, if the processing logic determines that the command sent from the host is not a use command, the process moves to processing block 855. At processing block 855, processing logic determines if the hard drive is use enabled. If yes, the hard drive processes other commands from the host. If no, the hard drive does not enable use by the host.

It will be appreciated that more or fewer processes may be incorporated into the method(s) illustrated in FIGS. 5, 6, 7,and 8 without departing from the scope of the invention and that no particular order is implied by the arrangement of blocks shown and described herein. It further will be appreciated that the method(s) described in conjunction with FIGS. 5, 6, 7, and 8 may be embodied in machine-executable instructions, e.g., software. The instructions can be used to cause a general-purpose or special-purpose processor that is programmed with the instructions to perform the operations described.

Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

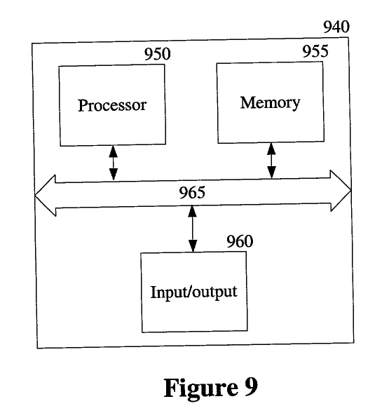

One embodiment of a computer system suitable for use as the configuration host 340 or current host 240 of FIGS. 3a and 3b is illustrated in FIG. 9. The computer system 940, includes a processor 950, memory 955 and input/output capability 960 coupled to a system bus 965. The memory 955 is configured to store instructions which, when executed by the processor 950, perform the methods described herein. The memory 955 may also store the input and currently edited video content. Input/output 960 provides for the delivery and display of the video content or portions or representations thereof. Input/output 960 also encompasses various types of computer-readable media, including any type of storage device that is accessible by the processor 950. One of skill in the art will immediately recognize that the term “computer-readable medium/media” further encompasses a carrier wave that encodes a data signal. It will also be appreciated that the server is controlled by operating system software executing in memory 955. Input/output and related media 960 store the computer-executable instructions for the operating system and methods of the present invention as well as the video content.

The description of FIG. 9 is intended to provide an overview of computer hardware and other operating components suitable for implementing the invention, but is not intended to limit the applicable environments. It will be appreciated that the computer system 940 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

Although the present invention has been described with reference to specific embodiments, the specification and drawings are to be regarded as illustrative rather than restrictive.

What is claimed is:

1. A method of locking hard drive to a particular host comprising:
transmitting a challenge to a current host;
receiving an encoded result from the current host;
verifying the encoded result against the challenge using a first key associated with the particular host; and
denying access to the hard drive if the verification fails.

2. The method of claim 1 wherein transmitting comprises:
transmitting the challenge to the current host if a lock bit is set.

3. The method of claim 2 wherein transmitting comprises:
transmitting the challenge to the current host after a specified signal is sent from the current host.

4. The method of claim 3 wherein the specified signal is a status command.

5. The method of claim 1, wherein the verifying comprises:
decrypting the encoded result using the first key; and
comparing the result of the decoding with the challenge.

6. The method of claim 5 wherein the first key is a secret symmetric key.

7. The method of claim 6 a symmetrical cryptography algorithm is selected from the group consisting of Digital Encryption Standard (DES), Triple-DES, Advanced Encryption Algorithm (AES), Blowfish, or M6.

8. The method of claim 5 wherein the first key is part of a public key cryptography key pair.

9. The method of claim 8 wherein the public key cryptographic algorithm is selected from the group consisting of RSA, Elliptic Curve, N-tru, or Diffie-Hellman.

10. The method of claim 1, wherein the verifying comprises:
hashing the challenge using the first key; and
comparing the encoded result with the hash.

11. The method of claim 10 wherein the hashing is done using an algorithm selected from the group consisting of Secure Hashing Algorithm rev.1 (SHA-1), or MD5.

12. The method of claim 1 wherein the denying comprises:
refusing communication with the current host.

13. The method of claim 1 wherein the denying comprises:
erasing contents of the hard drive.

14. The method of claim 1 wherein the host is selected from the group consisting of a set-top box, personal computer, laptop computer, personal data assistant, home entertainment system, or music player.

15. The method of claim 2 wherein the lock bit is selected from the group consisting of one time programmable (OTP) memory, flash; fuse, or electrically erasable programmable read-only memory (EEPROM) memory.

16. The method of claim 2 further comprising:
receiving the first key;
storing the first key if the lock bit is not set; and
setting the lock bit in response to receiving the first key if the lock bit is not set.

17. The method of claim 16 further comprising:
sending the first key if the lock bit is not set.

18. The method of claim 1 further comprising:
receiving the challenge;
encoding the challenge using a second key associated with the current host; and
sending the encoded result.

19. The method of claim 18, wherein encoding the challenge comprises:
encrypting the challenge using the second key.

20. The method of claim 19 wherein the first and second keys are secret symmetric keys.

21. The method of claim 20 wherein a symmetrical cyptology algorithm is selected from the group consisting of Digital Encryption Standard (DES), Triple-DES, Advanced Encryption Algorithm (AES), Blowfish, or M6.

22. The method of claim 19 wherein the first and second keys are a public key cryptography key pair.

23. The method of claim 22 wherein the public key cryptographic algorithm is selected from the group consisting of RSA, Elliptic Curve, N-tru, or Diffie-Hellman.

24. The method of claim 18, wherein encoding the challenge comprises:
hashing the challenge using the second key.

25. The method of claim 24 wherein the hashing is done using an algorithm selected from the group consisting of Secure Hashing Algorithm rev.1 (SHA-1), or MD5.

26. A method of unlocking a locked hard drive comprising:
receiving a master key; and
unlocking the hard drive if the master key is valid.

27. The method of claim 26 wherein the master key is unique to one hard drive.

28. The method of claim 26 wherein the master key changes based on a secret algorithm.

29. A computer-readable medium having computer-executable instructions for performing a method of locking a hard drive to a particular host comprising:
transmitting a challenge to a current host;
receiving an encoded result from the current host;
verifying the encoded result against the challenge using a first key associated with the particular host; and
denying access to the hard drive if the verification fails.

30. The computer-readable medium of claim 29 wherein the transmitting comprises:
transmitting the challenge to the current host if a lock bit is set.

31. The computer-readable medium of claim 29 wherein the verifying comprises:
decrypting the encoded result using the first key; and
comparing the result of the decoding with the challenge.

32. The computer-readable medium of claim 29 wherein the verifying comprises:
hashing the challenge using the first key; and
comparing the encoded result with the hash.

33. The computer-readable medium of claim 29 wherein the denying comprises:
refusing communication with the current host.

34. The computer-readable medium of claim 29 wherein the denying comprises:
erasing contents of the hard drive.

35. The computer-readable medium of claim 30 further comprising:
receiving the first key;
storing the first key if the lock bit is not set; and
setting the lock bit in response to receiving the first key if the lock bit is not set.

36. The computer-readable medium of claim 29 further comprising:
receiving the challenge;
encoding the challenge using a second key associated with the current host; and
sending the encoded result.

37. A computer system comprising:
a processing unit coupled to a memory through a system bus; and
a lockable hard drive process executed from the memory by the processing unit to cause the processing unit to transmit a challenge to a current host, receive an encoded result from the current host, verify the encoded result against the challenge using a first key associated with the particular host, and deny access to the hard drive if the verification fails.

38. The computer system of claim 37 wherein the lockable hard drive process further causes the processing unit to transmit a challenge to a current host if a lock bit is set.

39. The computer system of claim 37 wherein the lockable hard drive process causes the processing unit to verify the encoded result against the challenge using a first key associated with the particular host by decrypting the encoded result using the first key, and comparing the result of the decoding with the challenge.

40. The computer system of claim 37 wherein the lockable hard drive process causes the processing unit to verify the encoded result against the challenge using a first key associated with the particular host by hashing the challenge using the first key, and comparing the encoded result with the hash.

41. The computer system of claim 37 wherein the lockable hard drive process further causes the processing unit to receive a first key, store the first key if the lock bit is not set, and set the lock bit in response to receiving the first key if the lock bit is not set.

42. The computer system of claim 37 wherein the lockable hard drive program further causes the processing unit to receive the challenge, encode the challenge using a second key associated with the current host, and send the encoded result.
